(19) United States
(12) Patent Application Publication
(10) Pub. No.: US 2026/0242550 A1
(43) Pub. Date: Aug. 20, 2026

(54) MICROFIBER AND GRAPHENE REINFORCED POLYMER MATRIX COMPOSITES AND METHODS OF PREPARATION THEREOF

(71) Applicant: Rutgers, The State University of New Jersey, New Brunswick, NJ (US)

(72) Inventors: Thomas J. Nosker, Stockton, NJ (US); Hao-Wei Yen, East Brunswick, NJ (US); Mark N. Mazar, Piscataway, NJ (US); Arya S. Tewatia, Piscataway, NJ (US); Kyler Mckee, Red Bank, NJ (US)

(73) Assignee: Rutgers, The State University of New Jersey, New Brunswick, NJ (US)

(21) Appl. No.: 19/161,763

(22) PCT Filed: Mar. 1, 2024
(86) PCT No.: PCT/US2024/018175

§ 371 Date: Sep. 3, 2025

Related U.S. Application Data
(60) Provisional application No. 63/488,398, filed on Mar. 3, 2023.

(51) Int. Cl. C08J 5/04; C08J 5/08; C08K 3/04; C08K 7/06

(52) U.S. Cl. CPC C08J 5/042; C08J 5/08; C08K 3/042; C08K 7/06; C08J 2323/12; C08J 2329/12; C08J 2367/03; C08J 2377/00

(57) ABSTRACT

The present disclosure provides novel microfiber and graphene reinforced polymer matrix composites and methods for producing them. The disclosed microfiber and graphene reinforced polymer matrix composites show improvements in mechanical properties, such as stiffness, tensile strength, and impact energy absorption.

### CROSS REFERENCE TO RELATED APPLICATIONS

This application claims priority under 35 U.S.C. § 119(e) to U.S. Provisional Patent Application Ser. No. 63/488,398, filed Mar. 3, 2023, which is hereby incorporated by reference in its entirety.

### FIELD OF THE INVENTION

The present invention relates to microfiber and graphene reinforced polymer matrix composites formed by reinforcing graphene-reinforced polymer matrix composites with microfibers.

### BACKGROUND OF THE INVENTION

Polymer compositions are being increasingly used in a wide range of areas that have traditionally employed the use of other materials, such as metals. Polymers possess a number of desirable physical properties, are lightweight, and are inexpensive. In addition, many polymer materials may be formed into a number of various shapes and forms and exhibit significant flexibility in the forms that they assume, and may be used as coatings, dispersions, extrusion and molding resins, pastes, powders, and the like.

There are various applications for which it would be desirable to use polymer compositions, which require materials with mechanical strength properties equivalent to metals. However, a significant number of polymeric materials and composites fails to be intrinsically strong enough for many of these applications. For instance, thermoplastic polymers exhibit intrinsically low tensile modulus, i.e., stiffness, value less than 5 GPa which limits the applicability of the polymers that require any load bearing applications. As such, various modifications have been attempted to increase the mechanical properties of the neat polymer composition.

In one application, fiber reinforced polymers (FRPs) comprising polymers coated on the surface with micron-sized fibers have been explored to enhance the shear strength of the composite. However, mere surface reinforcement between the materials interface limits the mechanical property enhancement and thus hinders the use in commercial applications that require more robust materials including aircraft and aerospace systems, automotive systems and vehicles, electronics, government defense/security, pressure vessels, and reaction chambers.

More recently, nanoscale graphene or fiber reinforcements have been utilized to increase the stiffness of the composite. The nanoscale reinforcement requires distributing fiber materials or graphene into a molten polymer phase achieving reinforcements in the composite that exhibit improved mechanical properties. The resulting fiber or graphene-thermoplastic composites have been shown to exhibit 2 to 6 times increase in stiffness when compared to the unreinforced, neat polymers. However, stiffness of the graphene-reinforced polymer matrix composite still falls well short compared to conventional materials such as aircraft-grade aluminum and other metals and alloys due to the upper bound limitation in the composite stiffness according to the linear law of mixture associated with composite materials.

Typical aircraft-grade aluminum used in automotive systems possesses a stiffness value of around 69 GPa. Comparatively, the highest stiffness achieved by either the microscale carbon fiber-reinforced polymer or the nanoscale graphene-reinforced polymer composite is capped at 30 GPa. Therefore, there exists a need to provide a solution to overcome the maximum stiffness limit while providing a material platform that is lighter, and economically scalable. One such proposed solution is a multi-scale, dual-reinforced polymer matrix composite comprising a graphene-reinforced matrix composite, that is further reinforced with carbon-based microfiber reinforcers, i.e., a microfiber and graphene reinforced polymer matrix composite (herein referred to as MF-G-PMCs). Such multi-scale reinforcement provides both nano-scale reinforcement between graphene and polymer, and micro-scale reinforcement that offers additional reinforcement within the matrix composite.

Progress in the development of low-cost methods to effectively produce microfiber and graphene reinforced polymer matrix composites remains very slow. Currently, some of the challenges that exist affecting the development of MF-G-PMCs viable for use in real-world applications include the expense of the materials and the impracticality of the presently used chemical and/or mechanical manipulations for large-scale commercial production. It would thus be desirable for a low-cost method to produce MF-G-PMCs suitable for large-scale commercial production that offers many property advantages including lower material density, nonlinear increase of mechanical properties, enhanced electrical/thermal conductivity, and transparency to X-rays and electromagnetic pulse (EMP).

### SUMMARY OF THE INVENTION

The present disclosure relates to the discovery that a multi-scale reinforcement via microfiber and graphene reinforcements of thermoplastic polymer matrix composites can be created, making it possible to get a very high stress transfer in the resulting composite. Thus, the disclosure provides stiffer and stronger microfiber and graphene reinforced polymer matrix composites and methods for producing them.

One aspect of the invention is directed to a method for producing a microfiber and graphene reinforced polymer matrix composite, comprising:
distributing graphite microparticles into a first molten thermoplastic polymer phase comprising at least one thermoplastic polymer;
exfoliating the graphite microparticles in the first molten thermoplastic polymer phase by applying a first succession of shear strain events to the first molten thermoplastic polymer phase so that the first molten thermoplastic polymer phase at least partially exfoliates the graphite microparticles into single- and multi-layer graphene nanoparticles to obtain a graphene-reinforced polymer matrix composite, wherein the shear strain event is equal to or greater than the Interlayer Shear Strength (ISS) of the graphite microparticles; and
distributing microfibers and additional thermoplastic polymer to the graphene-reinforced polymer matrix composite while continuing to apply a second succession of the shear strain events until graphene fractures of the exfoliated single- and/or multi-layer graphene nanoparticles are formed across the basal plane defined by the a-axis and b-axis of the exfoliated particles, wherein the edges of the graphene fractures comprise reactive free radical graphenic carbon bonding sites that react with the one or more molten thermoplastic polymers to provide a composite where thermoplastic polymer chains are directly covalently bonded to, and inter-molecularly cross-linked by, the single- and/or multi-layer graphene nanoparticles.

In various embodiments, the first succession of shear strain events may be applied until about 20% to about 100% of the graphite microparticles is exfoliated to form a distribution in the molten thermoplastic polymer phase of single- and multi-layer graphene nanoparticles. In some embodiments, the succession of shear strain events may be applied until about 50% to about 100% of the graphite microparticles is exfoliated to form a distribution in the molten thermoplastic polymer phase of single- and multi-layer graphene nanoparticles. In some embodiments, the first molten thermoplastic polymer phase may comprise about 40 wt. % to about 100 wt. % of the total polymer weight. In various embodiments, the second molten thermoplastic polymer phase may comprise about 0 wt. % to about 60 wt. % of the total polymer weight.

In various embodiments, the first succession of shear strain events may be applied until graphene fractures of the exfoliated single and/or muti-layer graphene nanoparticles are formed across the basal plane defined by the a-axis and b-axis of the exfoliated particles, wherein the edges of the graphene fractures comprise reactive free radical graphenic carbon bonding sites that react with thermoplastic polymer chains to provide a composite where thermoplastic polymer chains are directly covalently bonded to and inter-molecularly cross-linked by the single- and multi-layer graphene nanoparticles.

Another aspect of the invention is directed to a microfiber and graphene reinforced polymer matrix composite comprising an essentially uniform distribution in a thermoplastic polymer matrix of between 0.01 wt. % to about 50 wt. % by total composite weight of the graphene nanoparticles and graphite microparticles; about 10 wt. % and about 50 wt. % by total composite weight of graphene; between about 5 wt. % and about 55 wt. % by total composite weight of microfibers. In some embodiments, the microfiber and graphene reinforced polymer matrix composite may comprise from about 20 wt. % to about 60 wt. % of total composite weight of graphene nanoparticles, graphite microparticles, and microfibers.

In some embodiments of the above microfiber and graphene reinforced polymer matrix composite, the microfiber may be carbon fibers. In various embodiments, the carbon fibers may comprise single- or multi-walled carbon nanotubes (SWCNTs and MWCNTs, respectively), carbon nanofibers, micron-sized carbon fibers, chopped carbon fibers, and combinations thereof. In some embodiments, the microfibers may have a length ranging from about 3 mm to about 50 mm. In various embodiments, the microfibers may have a length ranging from about 10 mm to about 30 mm.

In various embodiments, the thermoplastic polymer may be selected from the group consisting of polyethylene terephthalate (PET), polyaryletherketones (PAEK), polyphenylene sulfides (PPS), polyethylene sulfide (PES), polyetherimides (PEI), polyvinylidene fluoride (PVDF), polysulfones (PSU), polycarbonates (PC), polyphenylene ethers, thermoplastic polyimides, liquid crystal polymers, thermoplastic elastomers, polyethylene (PE), polypropylene (PP), polystyrene (PS), acrylics, such as polymethylmethacrylate (PMMA), polyacrylonitrile (PAN), acrylonitrile butadiene styrene (ABS), polytetrafluoroethylene (PTFE/Teflon®), polyamides (PA) such as nylons, polyphenylene oxide (PPO), polyoxymethylene plastic (POM/Acetal), polyvinylchloride (PVC), and mixtures thereof.

In various embodiments, the microfiber and graphene reinforced polymer matrix composite prepared may comprise microfibers distributed into a molten polymer phase comprising exfoliated graphene, wherein said polymers are cross-linked by direct covalent bonds to the exfoliated graphene therein.

Another aspect of the invention is directed to a polymer composition comprising a host thermoplastic polymer and the microfiber and graphene reinforced polymer matrix composite of the present disclosure. In some embodiments, an automotive, aircraft, watercraft or aerospace part may be formed from the graphene-reinforced polymer matrix composites disclosed above. In one embodiment, embodiment the part may be an engine part.

Yet another aspect of the invention is directed to a high-strength microfiber and graphene reinforced polymer matrix composite prepared by a method comprising the steps of (a) forming the microfiber and graphene reinforced polymer matrix composite as disclosed above; and (b) distributing said polymer matrix composite into a non-cross-linked molten host thermoplastic polymer phase.

In various embodiments, the host thermoplastic polymer may be selected from the group consisting of polyethylene terephthalate (PET), polyaryletherketones (PAEK), polyphenylene sulfides (PPS), polyethylene sulfide (PES), polyetherimides (PEI), polyvinylidene fluoride (PVDF), polysulfones (PSU), polycarbonates (PC), polyphenylene ethers, thermoplastic polyimides, liquid crystal polymers, thermoplastic elastomers, polyethylene (PE), polypropylene (PP), polystyrene (PS), acrylics, such as polymethylmethacrylate (PMMA), polvacrylonitrile (PAN), acrylonitrile butadiene styrene (ABS), polytetrafluoroethylene (PTFE/Teflon®), polyamides (PA) such as nylons, polyphenylene oxide (PPO), polyoxymethylene plastic (POM/Acetal), polyvinylchloride (PVC), and mixtures thereof.

The details of one or more aspects of the disclosure are set forth in the description below. Other features, objects, and advantages of the technique described in this disclosure will be apparent from the description and from the claims.

### BRIEF DESCRIPTION OF THE DRAWINGS

FIG. 1 shows a graph of the tensile modulus of polyethylene terephthalate (PET) as a function of increasing graphene concentration prepared using high shear melt-processing of graphite microparticles.

FIG. 2 shows flexural stress-strain curves of graphene-reinforced polyethylene terephthalate (PET) as a function of increasing graphene concentration prepared using high shear melt-processing of graphite microparticles.

FIG. 3 shows the tensile modulus of neat and 35 wt. % graphene-reinforced thermoplastic polymer matrix composites prepared using high shear melt-processing.

FIG. 4A shows tensile modulus of PEEK, PA6, and PP polymers, neat and reinforced with 12 wt. % graphene and 40 wt. % carbon fiber loading.

FIG. 4B shows tensile strength of PEEK, PA6, and PP polymers, neat and reinforced with 12 wt. % graphene and 40 wt. % carbon fiber loading.

FIG. 5A shows tensile modulus of PEEK and PA6 polymers, neat and reinforced with 12 wt. % graphene and 40 wt. % carbon fiber loading.

FIG. 5B shows tensile strength of PEEK and PA6 polymers, neat and reinforced with 12 wt. % graphene and 40 wt. % carbon fiber loading.

FIG. 6A shows flexural modulus between carbon fiber only PA6 composite sample and carbon fiber and graphene reinforced PA6 composite samples.

FIG. 6B shows flexural modulus as function of graphene loading for various total carbon loaded PA6 composite samples.

FIG. 6C shows flexural modulus as function of carbon fiber loading for various total carbon loaded PA6 composite samples.

FIG. 6D shows flexural modulus as function of graphene to carbon fiber weight ratio for various total carbon loaded PA6 composite samples.

FIG. 7A shows tensile modulus between carbon fiber only PA6 composite sample and carbon fiber and graphene reinforced PA6 composite samples.

FIG. 7B shows tensile modulus as function of graphene loading for various total carbon loaded PA6 composite samples.

FIG. 7C shows tensile modulus as function of carbon fiber loading for various total carbon loaded PA6 composite samples.

FIG. 7D shows tensile modulus as function of graphene to carbon fiber weight ratio for various total carbon loaded PA6 composite samples.

FIG. 8A shows flexural modulus between carbon fiber only PET composite sample and carbon fiber and graphene reinforced PET composite samples.

FIG. 8B shows flexural modulus as function of graphene loading for various total carbon loaded PET composite samples.

FIG. 8C shows flexural modulus as function of carbon fiber loading for various total carbon loaded PET samples.

FIG. 8D shows flexural modulus as function of graphene to carbon fiber weight ratio for various total carbon loaded PET samples.

FIG. 9A shows tensile modulus between carbon fiber only PET composite sample and carbon fiber and graphene reinforced PET composite samples.

FIG. 9B shows tensile modulus as function of graphene loading for various total carbon loaded PET composite samples.

FIG. 9C shows tensile modulus as function of carbon fiber loading for various total carbon loaded PET composite samples.

FIG. 9D shows tensile modulus as function of graphene to carbon fiber weight ratio for various total carbon loaded PET composite samples.

### DETAILED DESCRIPTION OF THE INVENTION

The present disclosure provides a novel microfiber (e.g., carbon fiber) and graphene reinforced polymer matrix composite and the method of preparation thereof. The disclosed method is a low-cost, high-efficiency mixing process that further transforms a graphene-reinforced polymer matrix composite to an even stronger polymer composite by introducing microfibers into the composite. The microfiber and graphene reinforced polymer matrix composite of the present disclosure exhibits a nonlinear enhancement of mechanical properties with respect to the weight percentage of the nano- and micro-reinforcing agents added, and thus it is possible to achieve stiffness values that are far greater than those conventionally thought to be possible. The microfiber and graphene reinforced polymer matrix composite as disclosed offers numerous property advantages, including increased stiffness and tensile strength, enhanced electrical/thermal conductivity, and transparency to X-rays and electromagnetic pulse compared to unreinforced polymer composites. Furthermore, these properties are tunable by modification of the process.

As used in this document, the singular forms “a,” “an,” and “the” include plural references unless the context clearly dictates otherwise. Unless defined otherwise, all technical and scientific terms used here.

As used herein, the term “and/or” means any one of the items, any combination of the items, or all of the items with which this term is associated.

The compositions of the present invention can comprise, consist essentially of, or consist of the claimed ingredients. The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Publications disclosed herein are provided solely for their disclosure prior to the filing date of the present invention. Nothing herein is to be construed as an admission that the present invention is not entitled to antedate such publication by virtue of prior invention. Further, the dates of publication provided may be different from the actual publication dates which may need to be independently confirmed.

In one aspect, this disclosure provides a method for producing a microfiber and graphene reinforced polymer matrix composite. In some embodiments, the method may include:
distributing graphite microparticles into a first molten thermoplastic polymer phase comprising at least one thermoplastic polymer;
exfoliating the graphite microparticles in the first molten thermoplastic polymer phase by applying a first succession of shear strain events to the first molten thermoplastic polymer phase so that the first molten thermoplastic polymer phase at least partially exfoliates the graphite microparticles into single- and multi-layer graphene nanoparticles to obtain a graphene-reinforced polymer matrix composite, wherein the shear strain event is equal to or greater than the Interlayer Shear Strength (ISS) of the graphite microparticles; and
distributing microfibers and additional thermoplastic polymer to the graphene-reinforced polymer matrix composite while continuing to apply a second succession of the shear strain events until graphene fractures of the exfoliated single- and/or multi-layer graphene nanoparticles are formed across the basal plane defined by the a-axis and b-axis of the exfoliated particles, wherein the edges of the graphene fractures comprise reactive free radical graphenic carbon bonding sites that react with the one or more molten thermoplastic polymers to provide a composite where thermoplastic polymer chains are directly covalently bonded to, and inter-molecularly cross-linked by, the single- and/or multi-layer graphene nanoparticles.

As defined herein, “essentially uniform distribution or dispersion” (and any form of distribution and dispersion, such as “distributing” and “dispersing”) denotes that the graphene particles are well-mixed throughout the molten thermoplastic polymer phase, so that individual aliquots of the composite contain the same amount of graphene within about 10 wt. % of the average value, preferably within about 5 wt. % of the average value, more preferably within about 1 wt. % of the average value.

Graphite, the starting material from which graphene is formed, is composed of a layered planar structure in which the carbon atoms in each layer are arranged in a hexagonal lattice. The planar layers are defined as having an “a” and a “b” axis, with a “c” axis normal to the plane defined by the “a” and “b” axes. The graphene particles produced by the inventive method have an aspect ratio defined by the “a” or “b” axis distance divided by the “c” axis distance. Aspect ratio values for the inventive nanoparticles exceed 25:1 and typically range between 50:1 and 1000:1.

As used herein, the term “graphite” or “graphite microparticles” refers to graphite in which at least 50% of the graphite consists of multi-layer graphite crystals ranging between 1.0 and 1000 microns thick along the c-axis of the lattice structure. Typically, 75% of the graphite consists of crystals ranging between 100 and 750 microns thick. Expanded graphite may also be used. Expanded graphite is made by forcing the crystal lattice planes apart in natural flake graphite, thus expanding the graphite, for example, by immersing flake graphite in an acid bath of chromic acid, then concentrated sulfuric acid. Expanded graphite suitable for use in the present invention includes expanded graphite with opened edges at the bilayer level, such as MESOGRAF.

As used herein, the term “graphene” or “graphene nanoparticles” refers to the name given to a single layer of carbon atoms densely packed into a benzene-ring structure. Graphene, when used alone, may refer to multi-layer graphene, graphene flakes, graphene platelets, multi-layer graphene, few-layer graphene, or single-layer graphene in a pure and uncontaminated form.

In various exemplary embodiments, the microfiber and graphene reinforced composite matrix comprises carbon fibers. As used herein, the term “microfiber” refers to the name given to any high aspect ratio, fibrous structure that may be mixed with the graphene-reinforced polymer matrix composite to further reinforce the composite. Microfibers, when used alone, may refer to glass fibers, carbon fibers, polymeric fibers, metallic fibers, or fibers produced from natural materials.

As used herein, the term “carbon fibers” refers to at least 92 wt. % of elemental carbon bonded together in a long chain. Carbon fibers, when used alone, may comprise one or more single-walled carbon nanotubes, multi-walled carbon nanotubes, carbon nanofibers, or micron-sized carbon fibers, both in chopped, and uncut form.

Mechanical functionalization of graphene nanoparticles within a polymer matrix may be accomplished by a polymer processing technique that imparts repetitive high-shear strain events to exfoliate the graphite microparticles into graphene nanoparticles within the polymer matrix. As used herein, the phrase “succession of shear strain events” is defined as subjecting the molten polymer to an alternating series of higher and lower shear strain rates over essentially the same time intervals so that a pulsating series of higher and lower shear forces associated with the shear strain rate is applied to the graphite particles in the molten polymer. “Shear strain” is defined as the application of opposing forces along, or perpendicular to a plane or multiple planes to break the van der Waals interactions in the graphite microparticles. Higher and lower shear strain rates are defined as a first higher, shear strain rate that is at least twice the magnitude of a second lower shear strain rate. The first shear strain rate will range between 100 and 10,000 sec⁻¹. At least 1,000 to over 10,000,000 alternating pulses of higher and lower shear strain pulses are applied to the molten polymer to form the exfoliated graphene nanoparticles. The number of alternating pulses required to exfoliate graphite particles or graphite microparticles into graphene nanoparticles may be dependent on the original graphite particle dimensions at the beginning of this process, i.e., smaller original graphite particles may need a lower number of alternating pulses to achieve graphene than larger original graphite particles. This can be readily determined by one of ordinary skill in the art guided by the present specification without undue experimentation. After high-shear mixing, the graphite microparticles are exfoliated into multi- and single-layer graphene nanoparticle sheets and are uniformly dispersed in the molten polymer. Further discussion regarding method of forming of covalent conjugates of graphene and polymer chains is described in, for example, U.S. Pat. No. 11,479,652, the entire disclosure of which is incorporated herein by reference.

“Mechanical exfoliation,” as employed in this disclosure, is an in situ exfoliation process, which is distinct from other exfoliation methods, such as heat treatment, chemical exfoliation, microwave treatment, ultrasonic treatment, and the like. An advantage of mechanical exfoliation is that contamination-free graphene-polymer interfaces are formed during high-shear mixing, because newly formed graphene interfaces or fractures are not exposed to air or other chemicals. This ensures strong interface adhesion or bonding. Other advantages of in situ graphite microparticle mechanical exfoliation include: (a) no need to pre-form graphene by other methods (e.g., chemical, heat, microwave, or ultrasonic exfoliation); (b) graphite is much cheaper than graphene; and (c) it is much easier to handle graphite than graphene because graphene is floppy and difficult to be uniformly distributed in a molten polymer phase. Further discussion regarding in situ mechanical exfoliation is described in, for example, U.S. Pat. Nos. 11,098,175, 11,174,366, the entire disclosure of each of the documents is incorporated herein by reference.

In order to mechanically exfoliate graphite microparticles into single- and/or multi-layer graphene nanoparticles, the shear strain rate generated in the polymer during processing must cause shear stress in the graphite microparticles greater than the critical stress required to separate two layers of graphite microparticles, or the interlayer shear strength (ISS). The shear strain rate within the polymer is controlled by the type of polymer and the processing parameters, including the geometry of the mixer, processing temperature, and speed in revolutions per minute (RPM).

The required processing temperature and speed (RPM) for a particular polymer is determinable from polymer rheology data given that, at a constant temperature, the shear strain rate (γ) is linearly dependent upon RPM, as shown by Equation 1. The geometry of the mixer appears as the rotor radius, r, and the space between the rotor and the barrel, Δr.

$$\dot{γ} = ( \frac{2 π r}{Δ r} ) ( \frac{RPM}{60} ) \qquad Equation 1$$

The ISS of graphite ranges between 0.2 Mpa and 7 Gpa, but a new method has quantified the ISS at 0.14 Gpa. Thus, to mechanically exfoliate graphite in a polymer matrix during processing, the required processing temperature, shear strain rate, and RPM is determinable for a particular polymer from a graph of the log shear stress versus the log shear strain rate, collected for a polymer at a constant temperature, so that the shear stress within the polymer is equal to or greater than the ISS of graphite. Under typical processing conditions, polymers have sufficient surface energy to behave like the sticky side of adhesive tape, and thus are able to share the shear stress between the polymer melt and the graphite particles.

In one embodiment, the extrusion compounding elements are as described in U.S. Pat. No. 6,962,431, the disclosure of which is incorporated herein by reference, with compounding sections, known as axial fluted extensional mixing elements or spiral fluted extensional mixing elements. The compounding sections act to elongate the flow of the polymer and graphite microparticles, followed by repeated folding and stretching of the is material. This results in superior distributive mixing, which in turn, causes progressive breakage of the graphite microparticles. Batch mixers may also be equipped with equivalent mixing elements. In another embodiment, a standard-type injection molding machine is modified to replace the standard screw with a compounding screw for the purpose of compounding materials as the composition is injection molded. Such a device is disclosed in U.S. Pat. No. 9,533,432 and United States Patent Publication No. US 2022/0097259, the entire disclosure of each of the documents is incorporated herein by reference.

Automated extrusion systems are available to subject the composite material to as many passes as desired, with mixing elements as described in U.S. Pat. No. 6,962,431 and equipped with a re-circulating stream to direct the flow back to the extruder input. Since the processing of the graphene-reinforced polymer is direct and involves minimal handling of the materials, fabrication costs are low.

In various embodiments, graphite microparticles are added to the molten polymer and are mechanically exfoliated into graphene via the succession of shear strain events. Graphite microparticles are generally no greater than 1,000 microns in size, and the extent of exfoliation of the graphite microparticles can generally be from 1 to 100%, resulting in a graphene to graphite weight ratio ranging from 1:99 to 100:0. Such an exfoliation method is disclosed in U.S. Pat. No. 9,896,565, the entire disclosure of which is incorporated herein by reference.

It should be understood that essentially any polymer inert to graphite, graphite microparticles, or graphene nanoparticles, and capable of imparting sufficient shear strain to exfoliate graphene from the graphite microparticles may be used in the method of the present invention. Examples of such polymers include, without limitation, polyetheretherketones (PEEK), polyethylene terephthalate (PET), polyaryletherketones (PAEK), polyphenylene sulfides (PPS), polyethylene sulfide (PES), polyetherimides (PEI), polyvinylidene fluoride (PVDF), polysulfones (PSU), polycarbonates (PC), polyphenylene ethers, thermoplastic polyimides, liquid crystal polymers, thermoplastic elastomers, polyethylene (PE), polypropylene (PP), polystyrene (PS), acrylics, such as polymethylmethacrylate (PMMA), polyacrylonitrile (PAN), acrylonitrile butadiene styrene (ABS), polytetrafluoroethylene (PTFE/Teflon®), polyamides (PA) such as nylons, polyphenylene oxide (PPO), polyoxymethylene plastic (POM/Acetal), polyvinylchloride (PVC), and mixtures thereof and the like. Polymers capable of wetting the graphene surface may be used as well as high melting point, amorphous polymers in accordance with the method of the present invention.

In various embodiments of the present invention. “polyaryletherketone” (PAEK) may include polymers characterized by a molecular backbone having alternating ketone and ether functionalities. The very rigid backbone gives such polymers very high glass transition and melting temperatures compared to other plastics. The most common of these high-temperature-resistant materials is polyetheretherketone (PEEK). Other representatives of polyaryletherketones include PEKK (poly(etherketoneketone)), PEEEK (poly(etheretheretherketone)), PEEKK (poly(ether-etherketoneketone)), and PEKEKK (poly(etherketone-etherketoneketone)).

In various embodiments, microfiber and graphene reinforced polymer matrix composite may comprise a distribution in a thermoplastic polymer matrix between about 0.01 wt. % and about 50 wt. %, about 5 wt. % and about 40 wt. %, about 10 wt. % and about 30%, or about 15 wt. % and about 20 wt. % of the total composite weight of particles selected from two or more of graphite microparticles, single-layer graphene nanoparticles, and multi-layer graphene nanoparticles where at least 50 wt. % of the particles consist of single- and/or multi-layer graphene nanoparticles is less than 50 nanometers thick along a c-axis direction. Nonlimiting examples may include about 0.01 wt. % to about 5 wt. %, about 5 wt. %, about 10 wt. %, about 15 wt. %, about 20 wt. %, about 25 wt. %, about 30 wt. %, about 35 wt. %, about 40 wt. %, about 45 wt. %, or about 50 wt. % of the total composite weight of particles selected from two or more of graphite microparticles, single-layer graphene nanoparticles, and multi-layer graphene nanoparticles where at least 50 wt. % of the particles consist of single- and/or multi-layer graphene nanoparticles is less than 50 nanometers thick along a c-axis direction.

In some embodiments, the microfiber and graphene reinforced polymer matrix composite may comprise between about 0.01 wt. % and about 50 wt. %, about 5 wt. % and about 40 wt. %, about 10 wt. % and about 30 wt. %, or about 15 w t. % and about 20 wt. % of the total composite weight of graphene. Nonlimiting examples may include about 5 wt. %, about 10 wt. %, about 15 wt. %, about 20 wt. %, about 25 wt. %, about 30 wt. %, about 35 wt. %, about 40 wt. %, about 45 wt. %, or about 50 wt. % of the total composite weight of graphene.

In some embodiments, the graphene-reinforced polymer matrix composite (G-PMC) is further reinforced with microfibers by distributing one or more carbon-based microfiber materials to the graphene-reinforced polymer matrix composite under a condition suitable to mix the microfibers with the G-PMC to obtain microfiber and graphene reinforced polymer matrix composite (MF-G-PMC). The microfiber reinforcement may be applied to the graphene-reinforced polymer matrix composite by a conventional method including twin screw extrusion. As used herein, the term “reinforced” or “reinforcement” refers to strengthening a neat polymer or a polymer composite with graphene and microfiber additives to increase the mechanical properties such as stiffness and tensile strength compared to the base material. Further discussion regarding carbon fiber reinforcement of carbon-based nanomaterial is described in, for example, U.S. Pat. Nos. 11,059,945, 11,702,518, the entire disclosure of each of the documents is incorporated herein by reference.

In various embodiments, the microfiber reinforcement may be mixed with the graphene-reinforced polymer matrix composite by conventional methods, including twin screw extrusion. The duration of the shear strain event to uniformly distribute microfibers into graphene-reinforced polymer matrix composite may be dependent on various parameters, including but not limited to fiber dimension, mixing speed, tooling radius, and clearance of the extrusion system. This can be readily determined by one of ordinary skill in the art guided by the present specification without undue experimentation. After low shear mixing, the microfiber reinforcements are uniformly mixed with graphene-reinforced polymer matrix composite to produce a microfiber and graphene reinforced polymer matrix composite.

In some embodiments, various carbon-based microfibers may be utilized, including but not limited to single- or multi-walled carbon nanotubes (SWCNTs and MWCNTs, respectively), carbon nanofibers, micron-sized carbon fibers, or combinations thereof. In some embodiments, the carbon fibers may comprise a coating to prevent aggregation and fraying of the carbon fibers, and to provide optimal mixing and compatibility with various types of polymers. In various embodiments, the coating may comprise bisphenol A glycidyl ether epoxy, glycidyl amine epoxy, unsaturated polyester, polyether copolymer, acrylic polymer, polyurethane, acrylonitrile butadiene styrene, or mixtures thereof.

In various embodiments, microfiber and graphene reinforced polymer matrix composite may comprise between about 5 wt. % and about 55 wt. %, about 10 wt. % and about 50 wt. %, about 20 wt. % and about 45 wt. %, or about 25 wt. % and about 40 wt. % of the total composite weight of microfibers. In various embodiments, the microfiber and graphene reinforced polymer matrix composite may comprise between about 5 wt. % and about 15 wt. %, between about 15 wt. % and about 25 wt. %, between about 25 wt. % and about 35 wt. %, between about 35 wt. % and about 45 wt. %, or between about 45 wt. % and about 55 wt. % of the total composite weight of microfibers. Nonlimiting examples may include about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, or about 55 wt. % of the total composite weight of microfibers.

In some embodiments, the amount of graphite and graphene added to the molten polymer may be an amount up to and including the component to microfiber added (i.e., total carbon loading), provided that the total content of the microfibers and the resulting graphene or mixture of graphite and graphene does not exceed over 60 wt. %. Nonlimiting examples may include about 20 wt. %, about 25 wt. %, about 30 wt. %, about 35 wt. %, about 40 wt. %, about 45 wt. %, about 50 wt. %, about 55 wt. %, or about 60 wt. % of the total composite weight of graphite, graphene, and microfibers in molten polymer. In some embodiments, the weight ratio of graphene, or mixture of graphite and graphene to microfibers (G:MF) ranges between about 0.10 and about 10, about 0.10 and about 2, about 2 and about 4, about 4 and about 6, about 6 and about 8, or about 8 and about 10 when both graphene and microfibers are present. Nonlimiting examples of graphite/graphene to microfiber ratio may include about 0.5, about 1, about 1.5, about 2, about 2.5, about 3, about 3.5, about 4, about 4.5, about 5, about 5.5, about 6, about 6.5, about 7, about 7.5, about 8, about 8.5, about 9, about 9.5, or about 10 when both graphene and microfibers are present.

Typically, the diameter of microfiber is between about 5 and about 10 microns. In some embodiments. In various embodiments, the carbon fibers may be pre-cut or chopped prior to the incorporation into the G-PMC. In some embodiments, the length of the carbon fibers may be between about 3 mm and about 50 mm. In various embodiments, the length of the carbon fibers may be between about 3 mm to about 5 mm, about 5 mm and about 10 mm, about 10 mm and about 20 mm, about 20 mm and about 30, about 30 to about 40 mm, or about 40 mm to about 50 mm in length.

In some embodiments, the exfoliation of graphite and graphene in the molten polymer may be carried out in two steps. First, in the pre-exfoliation, or the first exfoliation step, graphite and graphene are introduced into a first molten polymer phase and first succession of shear strain events are applied and exfoliated. In various embodiments, the first succession of shear strain events may be applied until graphene fractures of the exfoliated single and/or muti-layer graphene nanoparticles are formed across the basal plane defined by the a-axis and b-axis of the exfoliated particles, wherein the edges of the graphene fractures comprise reactive free radical graphemic carbon bonding sites that react with thermoplastic polymer chains to provide a composite where thermoplastic polymer chains are directly covalently bonded to and inter-molecularly cross-linked by the single- and multi-layer graphene nanoparticles. In various embodiments, the pre-exfoliation step may comprise between about 0.01 wt. % and about 50 wt. %, about 5 wt. % and about 45 wt. %, about 10 wt. % and about 40%, about 15 wt. % and about 35 wt. %, about 20 wt. % and about 30 wt. %, about 25 wt. % and about 35 wt. %, about 0.01 wt. % and about 10 wt. %, about 10 wt. % and about 15 wt. %, about 15 wt. % and about 20 wt. %, about 20 wt. % and about 25 wt. %, about 25 wt. % and about 30 wt. %, about 30 wt. % and about 35 wt. %, about 35 wt. % and about 40 wt. %, about 40 wt. % and about 45 wt. %, or about 45 wt. % and about 50 wt. % of the total composite weight of graphite and graphene in molten polymer phase.

In some embodiments, the pre-exfoliation step may comprise between about 40 wt. % to about 100 wt. %, about 50 wt. % to about 90 wt. %, about 60 wt. % to about 80 wt. %, about 40 wt. % to about 50 wt. %, about 50 wt. % to about 60 wt. %, about 60 wt. % to about 70 wt. %, about 70 wt. % to about 80 wt. %, about 80 wt. % to about 90 wt. %, or about 90 wt. % to about 100 wt. % of the total polymer weight of the first molten thermoplastic polymer. Nonlimiting examples may include up to about 100 wt. %, up to about 90 wt. %, up to about 80 wt. %, up to about 70 wt. %, up to about 60 wt. %, up to about 50 wt. %, or up to about 40 wt. % of the total polymer weight of the first molten thermoplastic polymer. In various embodiments, the pre-exfoliation of graphite in molten polymer as result of repetitive shear strain events may result in between about 20% and about 100%, about 30% and about 90%, about 40% and about 80%, about 50% and about 70%, about 20% and about 30%, about 30% and about 40%, about 40% and about 50%, about 50% and about 60%, about 60% and about 70%, about 70% and about 80%, or about 80% and about 90%, or about 90% and about 100% exfoliation of graphite and graphene. In various embodiments, partial or complete exfoliation of graphite into graphene may generate dangling bonds having unoccupied valencies, i.e., free radicals, that provide the opportunity for various chemical reaction and cross-linking with the molten polymers to occur.

After the pre-exfoliation step, the pre-exfoliated product, now comprising the resulting partially or completely exfoliated graphite and graphene in molten polymer, may be mixed with microfibers and additional, second molten polymers to subsequently mix microfibers and is molten polymers with the pre-exfoliated product, i.e., microfiber mixing step. In various embodiments, the microfiber mixing step may comprise between about 5 wt. % and about 55 wt. %, about 10 wt. % and about 50 wt. %, about 15 wt. % and about 45 wt. %, about 20 wt. % and about 40 wt. %, about 25 wt. % and about 35 wt. %, about 5 wt. % and about 10 wt. %, about 10 wt. % and about 15 wt. %, about 15 wt. % and about 20 wt. %, about 20 wt. % and about 25 wt. %, about 25 wt. % and about 30 wt. %, about 30 wt. % and about 35 wt. %, about 35 wt. % and about 40 wt. %, about 40 wt. % and about 45 wt. %, or about 45 wt. % and about 50 wt. % of the total composite weight of microfibers.

In various embodiments, the incorporation of a second batch of molten polymer and the subsequent mixing by second shear-strain events with the pre-exfoliated product may result in additional exfoliation of graphite particles and tearing of the graphene flakes in the molten polymer that open additional free radicals that will provide additional cross-link with the molten polymer. In various embodiments, the second succession of shear events may be applied until graphene fractures of the exfoliated single- and/or multi-layer graphene nanoparticles are formed across the basal plane defined by the a-axis and b-axis of the exfoliated particles, wherein the edges of the graphene fractures comprise reactive free radical graphenic carbon bonding sites that react with the one or more molten thermoplastic polymers to provide a composite where thermoplastic polymer chains are directly covalently bonded to, and inter-molecularly cross-linked by, the single- and/or multi-layer graphene nanoparticles In various embodiments, the mixing step may comprise between about 0 wt. % to about 60 wt. %, about 10 wt. % to about 50 wt. %, about 20 wt. % to about 40 wt. %, about 0 wt. % to about 10 wt. %, about 10 wt. % to about 20 wt. %, about 20 wt. % to about 30 wt. %, about 30 wt. % to about 40 wt. %, about 40 wt. % to about 50 wt. %, or about 50 wt. % to about 60 wt. % of the total polymer weight of the second, additional molten thermoplastic polymer. Nonlimiting examples may include up to 60 wt. %, up to about 50 wt. %, up to about 40 wt. %, up to about 30 wt. %, up to about 20 wt. %, up to about 10 wt. %, or about 0 wt. % of the total polymer weight of the second molten thermoplastic polymer.

In some embodiments, the microfiber and graphene reinforced polymer matrix composite may be ground into particles and blended with non-cross-linked host polymers to serve as toughening agents for the host polymer. The non-cross-linked polymer acquires the properties of microfibers and graphene reinforced polymer matrix composite because of the chain entanglement between the two polymer species. The present invention, therefore also is includes cross-linked polymers of the present invention in particulate form that can be blended with other polymers to form a high-strength composite. In one embodiment, microfibers and graphene reinforced nylon-6 (PA6) and polyethylene terephthalate (PET) particles of the present invention can be used as toughening agents for the host polymers. Compositions according to the present invention may include host thermoplastic polymers reinforced with between about 1 wt. % and about 75 wt. %, about 10 wt. % and about 60 wt. %, about 20 wt. % and about 50 wt. %, or about 30 wt. % and about 40 wt. % of the microfiber and graphene reinforced polymer matrix composite particles of the present invention.

In some embodiments, examples of host polymers may include but are not limited to polyethylene terephthalate (PET), polyaryletherketones (PAEK), polyphenylene sulfides (PPS), polyethylene sulfide (PES), polyetherimides (PEI), polyvinylidene fluoride (PVDF), polysulfones (PSU), polycarbonates (PC), polyphenylene ethers, thermoplastic polyimides, liquid crystal polymers, thermoplastic elastomers, polyethylene (PE), polypropylene (PP), polystyrene (PS), acrylics, such as polymethylmethacrylate (PMMA), polyacrylonitrile (PAN), acrylonitrile butadiene styrene (ABS), polytetrafluoroethylene (PTFE/Teflon®, polyamides (PA) such as nylons, polyphenylene oxide (PPO), polyoxymethylene plastic (POM/Acetal), polyvinylchloride (PVC), mixtures thereof and the like. When the host polymer and the cross-linked polymer are the same polymer species, the cross-linked polymer particles are essentially a concentrated masterbatch of the degree of cross-linked species desired to be introduced to the polymer formulation.

The microfiber and graphene reinforced polymer matrix composite of the disclosure differs from a conventional neat polymer or graphene-reinforced polymer matrix composites in that there is a multi-scale reinforcement, first at the nano-level between the graphene and polymer matrix, and subsequently, at the micro-level between the graphene-polymer matrix composite and the microfiber reinforcers. It has been proposed that introducing a uniform distribution of microfiber reinforcers into a graphene-polymer matrix composite should yield a nonlinear enhancement in the mechanical properties such as material stiffness that far exceeds that of a linear enhancement observed in conventional graphene- or carbon fiber-reinforced polymer composites, which is limited by the law of mixture associated with composite materials.

This obstacle has now been overcome by a new processing method that involves high-shear mixing and exfoliation of graphite and graphene in a first molten polymer phase to produce a graphene-reinforced polymer matrix composite and then distributing second molten thermoplastic polymer phase and microfiber reinforcers with the graphene-reinforced polymer matrix composite to continue the exfoliation of graphite and graphene in the second molten thermoplastic polymer phase to obtain a microfiber and graphene reinforced polymer matrix composite exhibits superior mechanical properties compared to conventional reinforced polymers, metals and alloys.

The disclosed polymer composition comprising the host polymer and the microfiber and graphene reinforced polymer composite matrix will have very high specific strength properties and is suitable for automotive, aircraft, and aerospace applications. The present invention, therefore, also includes automotive, aircraft, and aerospace parts fabricated from said polymer composition, which can replace heavier metal parts without loss of mechanical or thermal properties. For example, the polymer composition can be used in engine components such as pistons, valves, camshafts, turbochargers and the like because of its high melting point and creep resistance. Forming the rotating portions of the turbine and compressor parts of a turbocharger, including respective blades, from the microfiber and graphene reinforced polymer matrix composite of the present invention will reduce turbocharger lag while improving fuel economy due to the resulting weight reduction. In other embodiments, the polymer composition can be used in interior and exterior automotive and aircraft components, including door and floor panels, seat frames, consoles, bumpers, trunk and hood, fender liners, suspension components, transmission, and electronic housings.

Thus, the resulting microfiber and graphene reinforced polymer matrix composite (MF-G-PMCs) produced by various embodiments of the present invention exhibits greater mechanical properties such as flexural and tensile moduli compared to conventional materials including neat polymers, fiber-reinforced polymer composites, graphene-reinforced polymer composites, aircraft-grade aluminum, other metals and alloys and subsequently, fabrication cost will be greatly reduced by this multi-scale, microfiber and graphene reinforced polymer matrix composite.

### EXAMPLES

The present invention is further illustrated by the following examples, which should not be construed as limiting in any way.

### Example 1: Flexural Properties of Graphene-Reinforced PET Composite (G-PET)

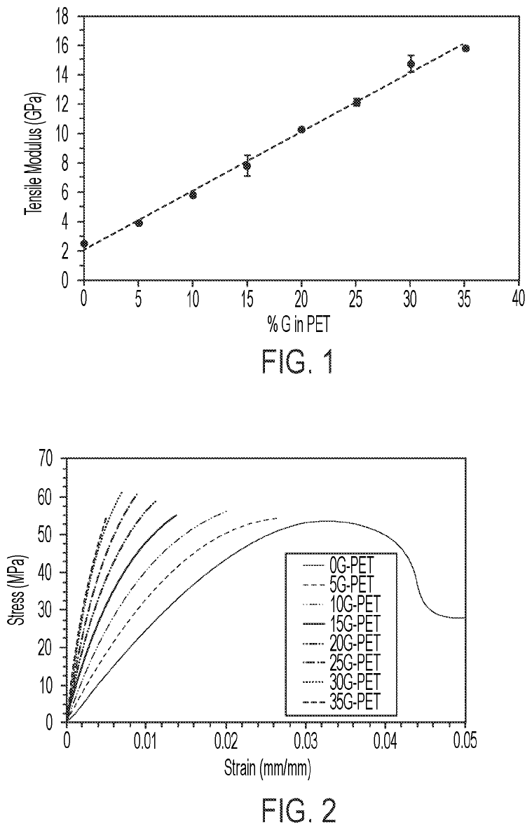

Graphite microparticles were fed directly into the hopper of a high, uniform shear injection molding machine with polyethylene terephthalate (PET) to produce 0, 5, 10, 15, 20, 25, 30, and 35 wt. % graphene-reinforced PET matrix composites using the method described in U.S. Pat. No. 9,896,565, the entire disclosure of which is incorporated herein by reference. Using a high-shear processing method described above, the graphite microparticles were exfoliated into single- and multi-layers graphene nanoparticles and bonded with the molten polymer phase. The interactions in the graphene-reinforced polymer matrix provide efficient load transfer and increased mechanical properties. Stiffness and flexural properties were determined with respect to the increased wt. % reinforcement of graphene (See FIGS. 1 and 2).

### Example 2: Mechanical Properties of Graphene-Reinforced Polymer Matrix Composites

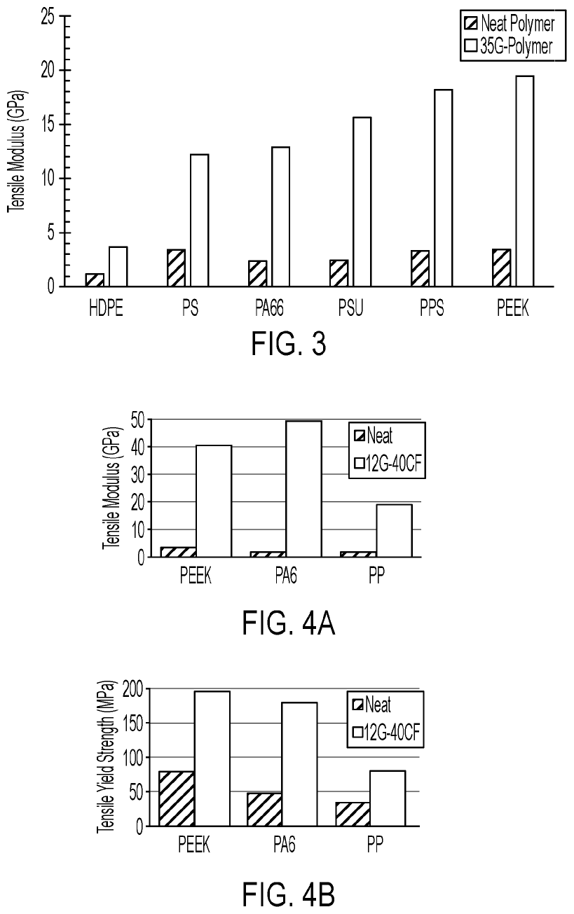

FIG. 3 displays the tensile modulus of various neat thermoplastic polymers and the same polymers reinforced with 35 wt. % graphene according to an embodiment described in Example 1. The thermoplastic polymers include high-density polyethylene (HDPE), polystyrene (PS), Nylon 6,6 (PA66), polysulfone (PSU), polyphenylene sulfide (PPS), and polyetheretherketone (PEEK). Upon loading 35 wt. % graphene into thermoplastic polymers by a high, uniform shear process, improvements up to a 6-fold increase in stiffness were observed in all graphene-reinforced polymer matrix composites.

### Example 3: Mechanical Properties of Carbon Fiber and Graphene Reinforced Polymer Matrix Composites (CF-G-PMC)

Table 1 shows the mechanical properties (e.g., stiffness and strength) of various materials, including neat polymers, microfiber and graphene reinforced polymer matrix composites, and an aircraft-grade aluminum (6061-T6) alloy. The table shows that compared to the neat, un-reinforced, polyetheretherketone (PEEK), Nylon 6 (PA6) and polypropylene (PP) polymers, said polymers reinforced with 40 wt. % carbon fiber and 12 wt. % graphene (40CF-12G) resulted in unexpected enhancements in both stiffness and strength up to 25× and 3.6× respectively. (FIGS. 4A and 4B).

TABLE 1
Properties of Aluminum (6061-T6) and three polymers, both
neat and reinforced with graphene and carbon fibers.

| | | Carbon | Tensile Modulus | | Tensile Strength | | Material |
|---|---|---|---|---|---|---|---|
| | Graphene | Fiber | | per | | per | Density |
| Material | wt. % | wt. % | (GPa) | Density | (MPa) | Density | (g/cm³) |
| Aluminum (6061-T6) | 0 | 0 | 68.9 | 25.5 | 276 | 102 | 2.70 |
| PEEK | 0 | 0 | 3.5 | 2.6 | 80 | 60 | 1.33 |
| PEEK (40CF-12G) | 12 | 40 | 40.5 | 31.4 | 198 | 153 | 1.29 |
| PA6 | 0 | 0 | 2.0 | 1.7 | 49 | 41 | 1.19 |
| PA6 (40CF-12G) | 12 | 40 | 49.7 | 35.5 | 180 | 129 | 1.40 |
| PP | 0 | 0 | 2.0 | 2.2 | 35 | 39 | 0.90 |
| PP (40CF-12G) | 12 | 40 | 19.2 | 18.1 | 81 | 76 | 1.06 |

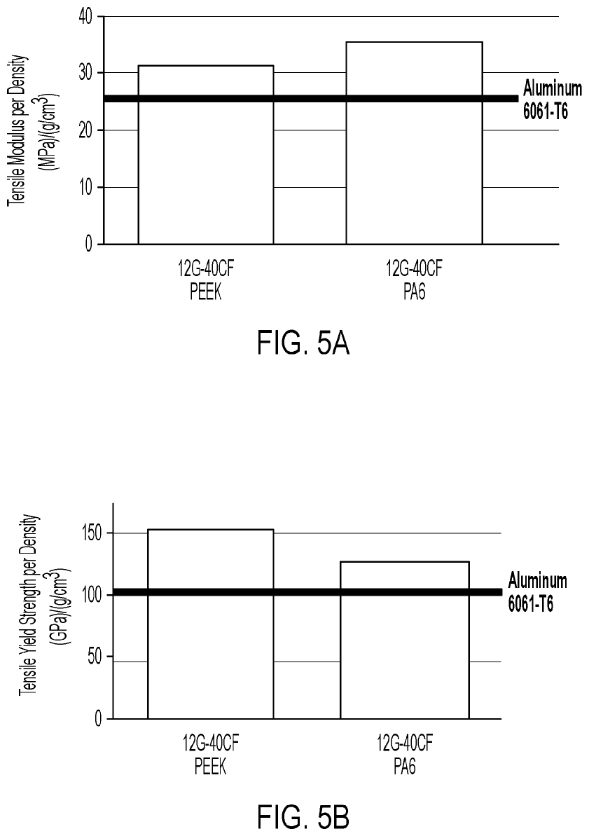

FIGS. 5A and 5B show stiffness and strength per density of 40CF-12G-PEEK and 30CF-12G-PA6 according to the embodiments of the present invention. While aluminum (6061-T6) is stiffer and stronger than 40CF-12G-PEEK and 40CF-12G-PA6 polymers, surprisingly, both 40CF-12G-PEEK and 40CF-12G-PA6 exhibited greater stiffness and tensile strength per density (i.e., specific stiffness and specific strength) compared to aluminum (6061-T6) making microfiber and graphene reinforced polymer matrix composites an ideal, alternative material to aircraft-grade aluminum that can support heavier payload while reducing the weight of the aircraft, thereby saving the fuel cost.

### Example 4: Carbon Fiber and Graphene Reinforced Polyamide 6 (CF-G-PA6)

In this example, carbon fiber and graphene reinforced PA6 were produced at total carbon loading % (graphene/graphite+carbon microfibers) of 20, 30, 35, 40, 45, and 50% each at an increasing graphene/graphite to carbon fiber weight ratios (G:CF) to the methods described in U.S. Pat. No. 9,896,565, the entire disclosure of which is incorporated herein by reference.

### Flexural Properties of CF-G-PA6

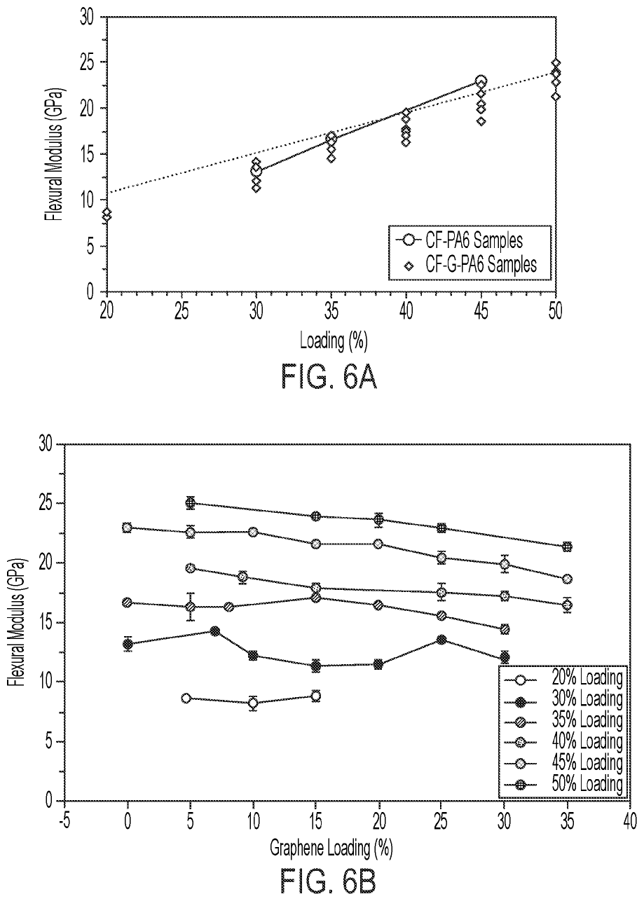

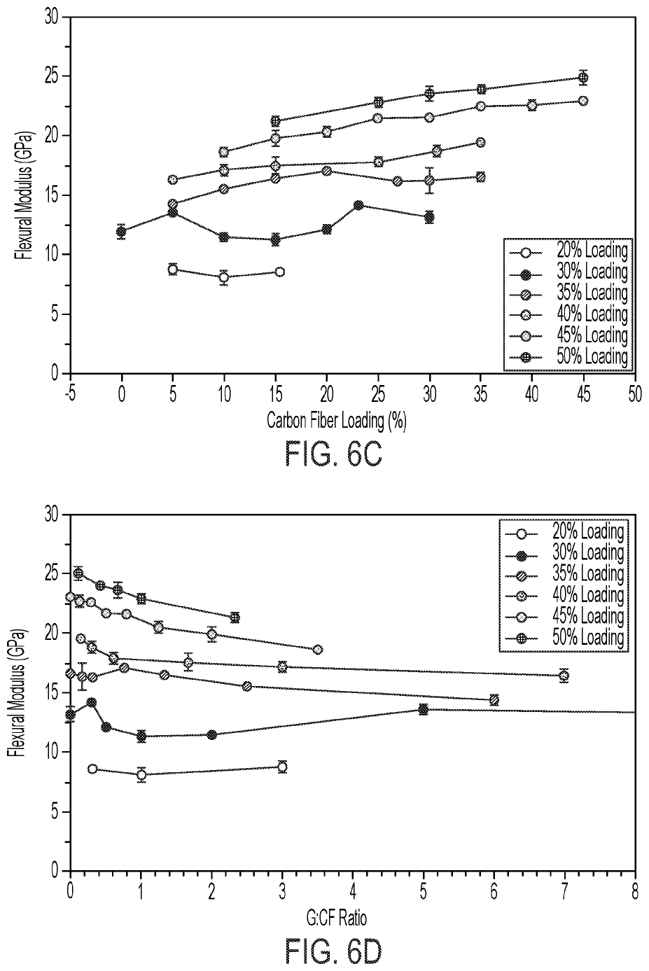

Flexural tests were performed on an MTS QTest/25 Universal testing system with a span of 53.8 mm and a test speed of 1.38 mm/min until failure or 0.55% strain, whichever occurred first. FIG. 6A shows an extrapolated modulus for the samples containing only carbon fiber (CF-PA6), i.e., 0 wt. % graphene loading, compared to the carbon fiber and graphene loaded samples (CF-G-PA6). As shown in Table 2, flexural tests indicate that with an increase in the total carbon loading, i.e., the amount of graphene/graphite and carbon fibers present in the polymer matrix, flexural modulus increases by almost three times from an average flexural modulus of 8.52 GPa at 20 wt. % total carbon loading to a maximum average flexural modulus of 23.36 GPa at 50 wt. % total carbon loading. (See FIGS. 6B-6D). Additionally, within each total carbon loading zone (i.e., 20, 30, 35, 50, 45, and 50%), the data show that at 20%, 40%, and 50% total carbon loading, the highest flexural modulus was observed at 5% graphene loading. In comparison, at 30% and 35% total carbon loading, the highest flexural modulus was observed at G:CF weight ratios of 0.3 and 0.75 respectively, indicating the effect of carbon fiber and graphene dual-reinforcement on the flexural properties. ((See FIGS. 6B-6C).

TABLE 2
Flexural Properties of CF-G-PA6

| Total | | | | | |
|---|---|---|---|---|---|
| Carbon | | | Stress at | Stress at | |
| Loading | | G:CF | Yield | Break | Modulus |
| (%) | Sample | Ratio | (MPa) | (Mpa) | (Gpa) |
| 20 | 15.4CF-5.62G-PA6 | 0.30 | 180.70 | 180.34 | 8.61 |
| | 10CF-10G-PA6 | 1.00 | 159.74 | 159.60 | 8.16 |
| | 5CF-15G-PA6 | 3.00 | 137.04 | 136.93 | 8.80 |
| 30 | 30CF-0G-PA6 | 0.00 | 262.45 | 261.17 | 13.16 |
| | 23.08CF-6.92G-PA6 | 0.30 | 213.19 | 213.10 | 14.21 |
| | 20CF-10G-PA6 | 0.50 | 196.77 | 196.52 | 12.17 |
| | 15CF-15G-PA6 | 1.00 | 177.41 | 177.27 | 11.34 |
| | 10CF-20G-PA6 | 2.00 | 159.33 | 159.23 | 11.51 |
| | 5CF-25G-PA6 | 5.00 | 137.58 | 137.48 | 13.62 |
| | 0CF-30G-PA6 | 30.00 | 116.43 | 116.30 | 11.94 |
| 35 | 35CF-0G-PA6 | 0.00 | 295.24 | 295.04 | 16.60 |
| | 30CF-5G-PA6 | 0.17 | 256.47 | 256.14 | 16.32 |
| | 26.92CF-8.08G-PA6 | 0.30 | 239.36 | 239.11 | 16.28 |
| | 20CF-15G-PA6 | 0.75 | 199.07 | 199.02 | 17.10 |
| | 15CF-20G-PA6 | 1.33 | 174.96 | 174.93 | 16.46 |
| | 10CF-25G-PA6 | 2.50 | 153.18 | 153.14 | 15.53 |
| | 5CF-30G-PA6 | 6.00 | 135.63 | 135.61 | 14.41 |
| 40 | 35CF-5G-PA6 | 0.14 | 270.44 | 270.31 | 19.52 |
| | 30.77CF-9.23G-PA6 | 0.30 | 237.53 | 237.43 | 18.80 |
| | 25CF-15G-PA6 | 0.60 | 209.42 | 209.37 | 17.84 |
| | 15CF-25G-PA6 | 1.67 | 169.12 | 169.08 | 17.54 |
| | 10CF-30G-PA6 | 3.00 | 151.95 | 151.92 | 17.22 |
| | 5CF-35G-PA6 | 7.00 | 130.59 | 130.57 | 16.36 |
| 45 | 45CF-0G-PA6 | 0.00 | 315.13 | 315.00 | 23.03 |
| | 40CF-5G-PA6 | 0.13 | 281.81 | 281.70 | 22.64 |
| | 35CF-10G-PA6 | 0.29 | 243.22 | 243.15 | 22.58 |
| | 30CF-15G-PA6 | 0.50 | 220.49 | 220.35 | 21.62 |
| | 25CF-20G-PA6 | 0.80 | 198.18 | 198.16 | 21.57 |
| | 20CF-25G-PA6 | 1.25 | 178.93 | 178.92 | 20.48 |
| | 15CF-30G-PA6 | 2.00 | 159.85 | 159.84 | 19.89 |
| | 10CF-35G-PA6 | 3.50 | 141.74 | 141.73 | 18.63 |
| 50 | 45CF-5G-PA6 | 0.11 | 277.67 | 277.19 | 24.98 |
| | 35CF-15G-PA6 | 0.43 | 194.35 | 194.31 | 23.95 |
| | 30CF-20G-PA6 | 0.67 | 184.70 | 184.69 | 23.65 |
| | 25CF-25G-PA6 | 1.00 | 159.56 | 159.50 | 22.89 |
| | 15CF-35G-PA6 | 2.33 | 159.89 | 159.87 | 21.31 |

### Tensile Properties of CF-G-PA6

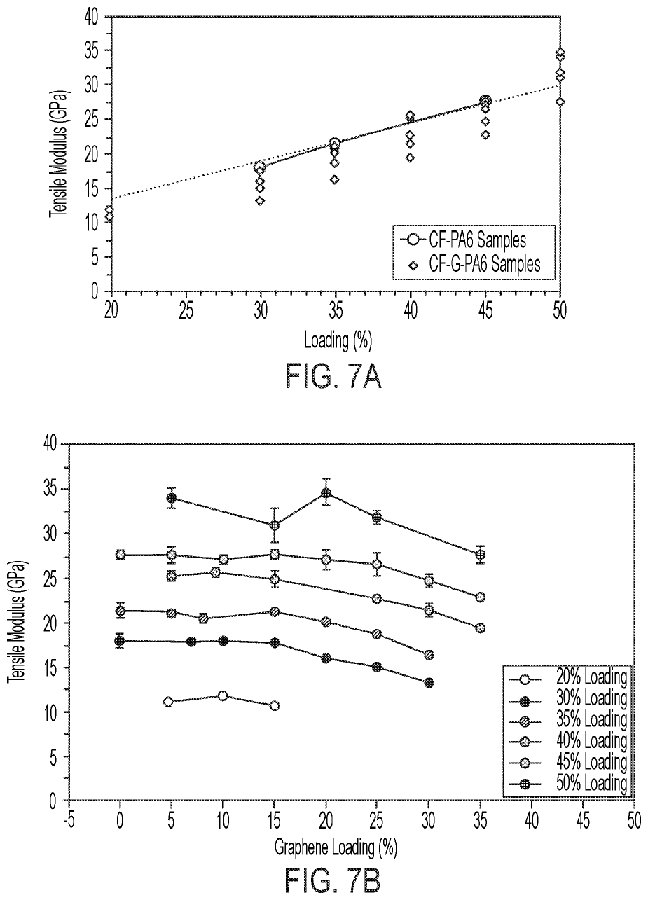

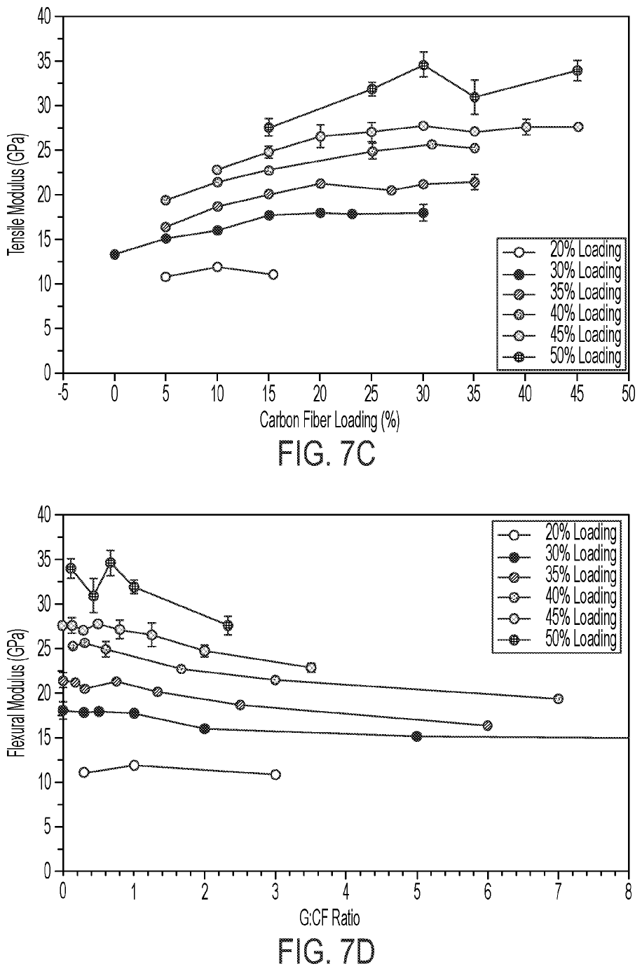

Tensile mechanical properties were performed on an MIS Qtest/25 universal testing system at a crosshead rate of 5.08 mm/m until failure or the limits of the load frame. FIG. 7A shows an extrapolated modulus for the samples containing only carbon fiber (CF-PA6), i.e., 0 wt. % graphene loading, compared to the carbon fiber and graphene reinforced PA6 samples (CF-G-PA6). As shown in Table 3 tensile tests indicate that with an increase in the total carbon loading, tensile modulus increased by almost three times from an average modulus of 11.28 GPa at 20 wt. % total carbon loading to a maximum average modulus of 31.80 GPa at 50 wt. % total carbon loading. (See FIGS. 71B-71D). Additionally, within each total carbon loading zone (i.e., 20, 30, 35, 50, 45, and 5000), the tensile modulus shows a general trend of increasing tensile modulus with increasing (decreasing) carbon fiber loading (G:CF ratio) ((See FIGS. 71B-7C).

TABLE 3
Tensile Properties of CF-G-PA6

| Total | | | | | | |
|---|---|---|---|---|---|---|
| Carbon | | | Stress at | Stress at | Energy | |
| Loading | | G:CF | Yield | Break | to Break | |
| (%) | Sample | Ratio | (MPa) | (MPa) | (MJ/m³) | Modulus (GPa) |
| 20 | 15.4CF-5.62G-PA6 | 0.30 | 114.00 | 113.58 | 3.40 | 11.09 |
| | 10CF-10G-PA6 | 1.00 | 101.97 | 101.90 | 2.24 | 11.88 |
| | 5CF-15G-PA6 | 3.00 | 87.79 | 87.77 | 1.57 | 10.87 |
| 30 | 30CF-0G-PA6 | 0.00 | 168.08 | 167.59 | 4.54 | 18.06 |
| | 23.08CF-6.92G-PA6 | 0.30 | 132.97 | 132.84 | 2.85 | 17.85 |
| | 20CF-10G-PA6 | 0.50 | 127.38 | 127.30 | 2.21 | 17.99 |
| | 15CF-15G-PA6 | 1.00 | 115.35 | 115.34 | 1.49 | 17.76 |
| | 10CF-20G-PA6 | 2.00 | 102.69 | 102.69 | 1.25 | 16.06 |
| | 5CF-25G-PA6 | 5.00 | 88.48 | 88.45 | 1.04 | 15.14 |
| | 0CF-30G-PA6 | 30.00 | 77.81 | 77.81 | 0.92 | 13.33 |
| 35 | 35CF-0G-PA6 | 0.00 | 187.50 | 187.26 | 4.09 | 21.44 |
| | 30CF-5G-PA6 | 0.17 | 159.37 | 159.22 | 3.39 | 21.19 |
| | 26.92CF-8.08G-PA6 | 0.30 | 147.93 | 147.86 | 2.87 | 20.54 |
| | 20CF-15G-PA6 | 0.75 | 127.43 | 127.43 | 1.51 | 21.29 |
| | 15CF-20G-PA6 | 1.33 | 112.63 | 112.63 | 1.17 | 20.10 |
| | 10CF-25G-PA6 | 2.50 | 99.57 | 99.57 | 0.91 | 18.72 |
| | 5CF-30G-PA6 | 6.00 | 86.02 | 86.00 | 0.82 | 16.33 |
| 40 | 35CF-5G-PA6 | 0.14 | 160.48 | 160.29 | 3.33 | 25.26 |
| | 30.77CF-9.23G-PA6 | 0.30 | 146.55 | 146.44 | 2.12 | 25.69 |
| | 25CF-15G-PA6 | 0.60 | 127.89 | 127.89 | 1.34 | 24.92 |
| | 15CF-25G-PA6 | 1.67 | 110.71 | 110.71 | 0.96 | 22.75 |
| | 10CF-30G-PA6 | 3.00 | 99.53 | 99.53 | 0.84 | 21.47 |
| | 5CF-35G-PA6 | 7.00 | 85.68 | 85.67 | 0.74 | 19.41 |
| 45 | 45CF-0G-PA6 | 0.00 | 189.79 | 189.41 | 3.93 | 27.60 |
| | 40CF-5G-PA6 | 0.13 | 167.55 | 167.42 | 2.76 | 27.60 |
| | 35CF-10G-PA6 | 0.29 | 149.15 | 149.13 | 1.77 | 27.04 |
| | 30CF-15G-PA6 | 0.50 | 139.11 | 139.10 | 1.26 | 27.74 |
| | 25CF-20G-PA6 | 0.80 | 125.46 | 125.46 | 0.93 | 27.12 |
| | 20CF-25G-PA6 | 1.25 | 115.30 | 115.30 | 0.78 | 26.55 |
| | 15CF-30G-PA6 | 2.00 | 103.92 | 103.92 | 0.71 | 24.77 |
| | 10CF-35G-PA6 | 3.50 | 95.15 | 95.15 | 0.64 | 22.88 |
| 50 | 45CF-5G-PA6 | 0.11 | 170.47 | 170.46 | 2.14 | 34.00 |
| | 35CF-15G-PA6 | 0.43 | 135.92 | 135.89 | 0.74 | 30.95 |
| | 30CF-20G-PA6 | 0.67 | 116.17 | 116.17 | 0.42 | 34.60 |
| | 25CF-25G-PA6 | 1.00 | 118.06 | 118.06 | 0.54 | 31.87 |
| | 15CF-35G-PA6 | 2.33 | 110.26 | 110.26 | 0.60 | 27.56 |

### Example 5: Carbon Fiber and Graphene Reinforced Polyethylene Terephthalate (CF-G-PET)

In this example, carbon fiber and graphene reinforced PET were produced at total carbon loading % (graphene/graphite+carbon microfibers) of 35, 45, and 55 wt. % each at an increasing graphene/graphite to carbon fiber ratios (G:CF).

### Flexural Properties of CF-G-PET

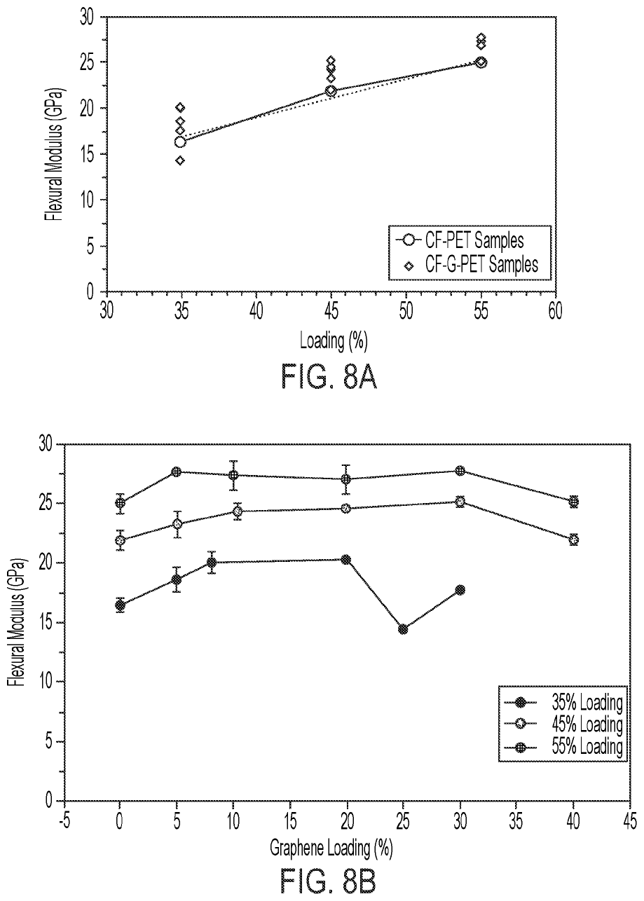

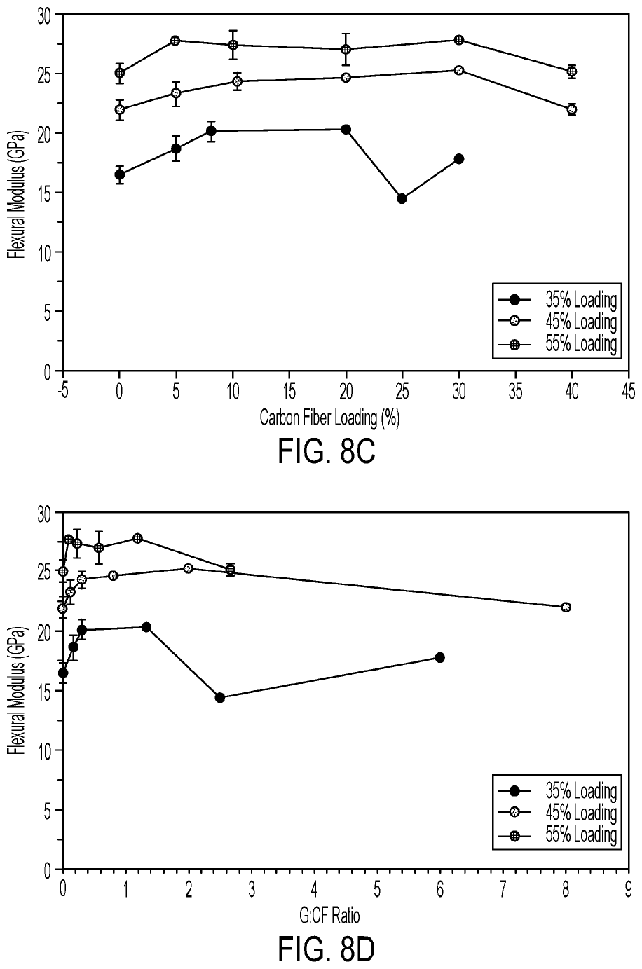

Flexural tests were performed on an MTS QTest/25 Universal testing system with a span of 53.8 mm and a test speed of 1.38 mm/min until failure or 0.55% strain, whichever occurred first. FIG. 8A shows flexural moduli according to total carbon loading (CF-G-PET) compared with the carbon fiber loaded samples (CF-PET) only. On average, CF-G-PET samples performed better than the CF only samples, indicating that replacing some of the carbon fibers with graphene results in an improved flexural property of the composite. As shown in Table 4, flexural tests further indicate that greater total carbon loading leads to an increase in the flexural modulus from an average modulus of 18.11 GPa at 35 wt. % total carbon loading to a maximum average modulus of 31.99 GPa at 55 wt. % total carbon loading. (See FIGS. 8B-8D).

Flexural tests show that in each loading zone (i.e., 35, 45, and 55%), the highest flexural modulus was observed when PET samples were loaded with both carbon fibers and graphene. For the 35 wt. % total carbon loading samples, there was a 23% increase in modulus from the CF only sample (35CF-OG-PET) at 16.45 GPa to the maximum modulus of 20.28 GPa for the 15CF-20G-PET sample. Additionally, 15% increase was observed at 45 wt. % total carbon loading for the 15CF-30G-PET sample with a modulus of 25.24 GPa compared to the CF only sample at 21.89 GPa. Finally, for 55 wt. % total carbon loading, an increase between 8% and 11% was seen for all samples between 0.1 and 1.2 G:CF weight ratios compared to the baseline, CF only (55CF-OG-PET) sample. The highest modulus was seen for the 25CF-30G-PET sample at 27.79 GPa. At every total carbon loading, a general trend of decreased stress and strain at yield was observed with increasing G:CF ratio.

TABLE 4
Flexural Properties of CF-G-PET

| Total | | | | | |
|---|---|---|---|---|---|
| Carbon | | G:CF | Stress at Yield | Stress at Break | Modulus |
| Loading (%) | Sample | Ratio | (MPa) | (Mpa) | (Gpa) |
| 35 | 35CF-0G-PET | 0.00 | 214.37 | 210.14 | 16.45 |
| | 30CF-5G-PET | 0.17 | 204.52 | 204.47 | 18.61 |
| | 26.92CF-8.08G-PET | 0.30 | 185.58 | 185.55 | 20.07 |
| | 15CF-20G-PET | 1.33 | 145.30 | 145.25 | 20.28 |
| | 10CF-25G-PET | 2.50 | 139.63 | 139.58 | 14.39 |
| | 5CF-30G-PET | 6.00 | 102.62 | 102.53 | 17.75 |
| 45 | 45CF-0G-PET | 0.00 | 233.68 | 233.16 | 21.89 |
| | 40CF-5G-PET | 0.13 | 203.92 | 203.81 | 23.28 |
| | 34.62CF-10.38G-PET | 0.30 | 178.74 | 178.70 | 24.31 |
| | 25CF-20G-PET | 0.80 | 151.50 | 151.42 | 24.60 |
| | 15CF-30G-PET | 2.00 | 123.99 | 123.77 | 25.24 |
| | 5CF-40G-PET | 8.00 | 94.17 | 94.02 | 21.95 |
| 55 | 55CF-0G-PET | 0.00 | 242.68 | 242.05 | 24.99 |
| | 50CF-5G-PET | 0.10 | 216.58 | 216.52 | 27.68 |
| | 45CF-10G-PET | 0.22 | 184.63 | 183.42 | 27.33 |
| | 35CF-20G-PET | 0.57 | 136.44 | 133.14 | 27.00 |
| | 25CF-30G-PET | 1.20 | 126.25 | 126.01 | 27.79 |
| | 15CF-40G-PET | 2.67 | 120.12 | 119.98 | 25.14 |

### Tensile Properties of CF-G-PET

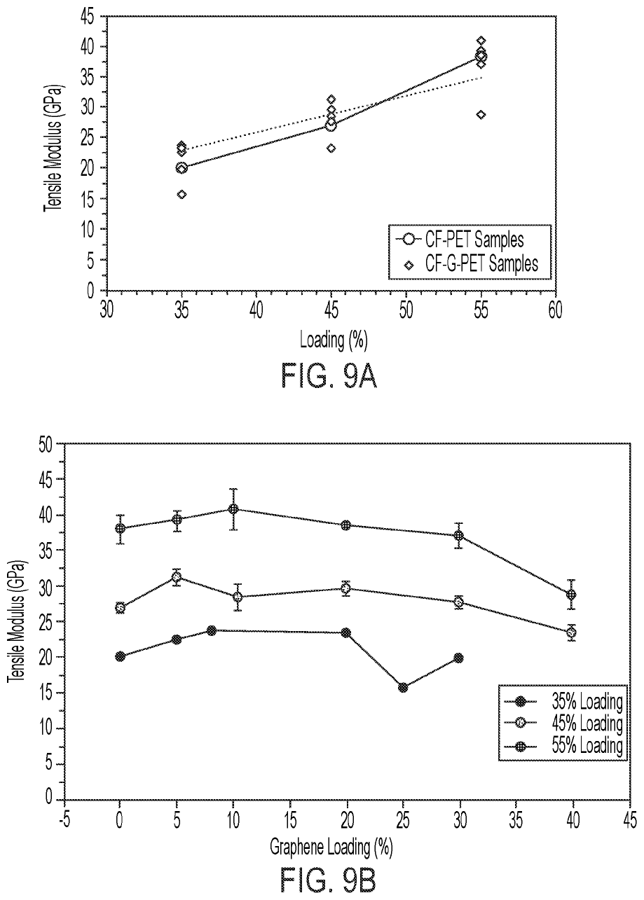

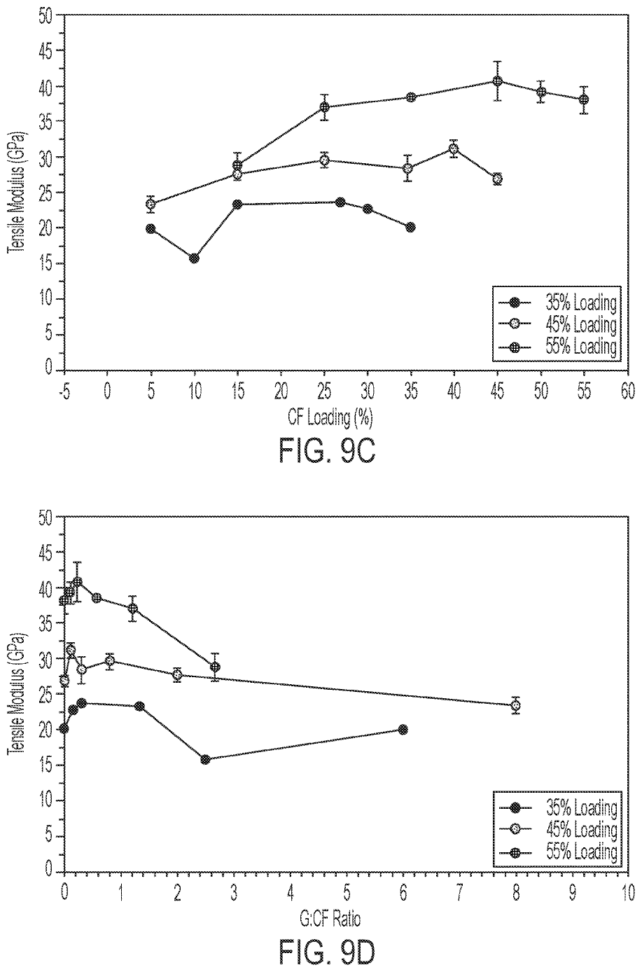

Tensile properties were performed on an MTS Qtest/25 universal testing system at a crosshead rate of 5.08 mm/min until failure or the limits of the load frame. FIG. 9A shows tensile moduli according to carbon fiber and graphene loaded (CF-G-PET) samples compared to carbon fiber loaded samples (CF-PET). The trendline indicating a linear modulus of the CF only sample shows that CF-G-PET samples perform better than the expected values compared to the CF only samples. As the tensile data in Table 5 show, the TOCF-25G-PET sample shows an outlier for tensile modulus data indicating a flaw in the sample's manufacturing process.

Similar to the flexural properties, in each total carbon loading zone (i.e., 35, 45, and 55%) the highest tensile modulus was observed wen PET samples were loaded with carbon fibers and graphene. Tensile tests show that at 35 wt. % total carbon loading, the maximum tensile modulus was measured as 23.70 GPa for the 25CF-10G-PET sample, an 18% increase over CF only (35CF-OG-PET) sample. For 45 wt. % total carbon loading, the maximum tensile modulus was measured at 31.20 GPa for the 40CF-5G-PET sample, a 16% increase over CF only (45CF-OG-PET) sample. Lastly, at 55% total carbon loading, the maximum tensile modulus was measured at 40.79 GPa for the 45CF-10G-PET sample, a 7% increase over the CF only (55CF-OG-PET) sample. ((See FIGS. 9B-9C).

TABLE 5
Tensile Properties of CF-G-PET

| Total | | | | | | |
|---|---|---|---|---|---|---|
| Carbon | | | Stress at | Stress at | Energy to | |
| Loading | | G:CF | Yield | Break | Break | |
| (%) | Sample | Ratio | (MPa) | (MPa) | (MJ/m³) | Modulus (GPa) |
| 35 | 35CF-0G-PET | 0.00 | 128.45 | 126.30 | 3.60 | 20.09 |
| | 30CF-5G-PET | 0.17 | 131.50 | 130.91 | 1.90 | 22.70 |
| | 26.92CF-8.08G-PET | 0.30 | 124.10 | 124.07 | 1.09 | 23.70 |
| | 15CF-20G-PET | 1.33 | 92.84 | 92.84 | 0.36 | 23.31 |
| | 10CF-25G-PET | 2.50 | 92.15 | 92.15 | 0.75 | 15.82 |
| | 5CF-30G-PET | 6.00 | 71.02 | 71.02 | 0.22 | 19.95 |
| 45 | 45CF-0G-PET | 0.00 | 144.50 | 143.28 | 3.11 | 26.97 |
| | 40CF-5G-PET | 0.13 | 135.11 | 134.57 | 1.49 | 31.20 |
| | 34.62CF-10.38G-PET | 0.30 | 120.05 | 120.05 | 0.66 | 28.45 |
| | 25CF-20G-PET | 0.80 | 99.55 | 99.55 | 0.33 | 29.63 |
| | 15CF-30G-PET | 2.00 | 78.46 | 78.46 | 0.19 | 27.69 |
| | 5CF-40G-PET | 8.00 | 62.13 | 62.13 | 0.13 | 23.43 |
| 55 | 55CF-0G-PET | 0.00 | 152.96 | 152.51 | 1.80 | 38.14 |
| | 50CF-5G-PET | 0.10 | 138.69 | 138.64 | 0.56 | 39.18 |
| | 45CF-10G-PET | 0.22 | 117.09 | 117.08 | 0.29 | 40.79 |
| | 35CF-20G-PET | 0.57 | 100.26 | 100.13 | 0.22 | 38.51 |
| | 25CF-30G-PET | 1.20 | 75.53 | 75.48 | 0.11 | 37.06 |
| | 15CF-40G-PET | 2.67 | 75.61 | 75.61 | 0.16 | 28.78 |

As carbon fiber is strongest along its axial direction due to the material's high-aspect ratio, replacing carbon fiber with more graphene removes strength along the axial direction. Thus, the largest increase in modulus from flex to tensile is seen in the samples with the most CF loading, where it is more likely for the carbon fibers to align along the axial direction, i.e., parallel to the type I tensile bar. Similarly, to the flexural data, stress at yield, strain at yield, and energy to break all decrease with increasing graphene content.

This disclosure is not limited to the particular systems, methodologies, or protocols described, as these may vary. The terminology used in this description is for the purpose of describing the particular versions or embodiments only, and is not intended to limit the scope.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

What is claimed is:

1. A method for forming a microfiber and graphene reinforced polymer matrix composite, comprising:
distributing graphite microparticles into a first molten thermoplastic polymer phase comprising at least one thermoplastic polymer;
exfoliating the graphite microparticles in the first molten thermoplastic polymer phase by applying a first succession of shear strain events to the first molten thermoplastic polymer phase so that the first molten thermoplastic polymer phase at least partially exfoliates the graphite microparticles into single- and multi-layer graphene nanoparticles to obtain a graphene-reinforced polymer matrix composite, wherein the shear strain event is equal to or greater than the Interlayer Shear Strength (ISS) of the graphite microparticles; and
distributing microfibers and a second thermoplastic polymer to the graphene-reinforced polymer matrix composite while continuing to apply a second succession of the shear strain events until graphene fractures of the exfoliated single- and/or multi-layer graphene nanoparticles are formed across the basal plane defined by the a-axis and b-axis of the exfoliated particles, wherein the edges of the graphene fractures comprise reactive free radical graphenic carbon bonding sites that react with the one or more molten thermoplastic polymers to provide a composite where thermoplastic polymer chains are directly covalently bonded to, and inter-molecularly cross-linked by, the single- and/or multi-layer graphene nanoparticles.

2. The method of claim 1, wherein the first succession of shear strain events may be applied until about 20% to about 100% of the graphite microparticles is exfoliated to form a distribution in the first molten thermoplastic polymer phase of single- and multi-layer graphene nanoparticles.

3. (canceled)

4. The method of claim 1, wherein the first molten thermoplastic polymer phase comprises about 40 wt. % to about 100 wt. % of the total polymer weight.

5. The method of claim 1, wherein the second thermoplastic polymer comprises about 0 wt. % to about 60 wt. % of the total polymer weight.

6. The method of claim 1, wherein the first succession of shear strain events are applied until graphene fractures of the exfoliated single and/or muti-layer graphene nanoparticles are formed across the basal plane defined by the a-axis and b-axis of the exfoliated particles, wherein the edges of the graphene fractures comprise reactive free radical graphenic carbon bonding sites that react with thermoplastic polymer chains to provide a composite where thermoplastic polymer chains are directly covalently bonded to and inter-molecularly cross-linked by the single- and multi-layer graphene nanoparticles.

7. The method of claim 1, wherein the first and the second thermoplastic polymer phases comprise same thermoplastic polymer.

8. The method of claim 1, wherein the microfiber and graphene reinforced polymer matrix composite comprises from about 0.01 wt. % to about 50 wt. % by total composite weight of the graphene nanoparticles and graphite microparticles.

9. (canceled)

10. (canceled)

11. The method of claim 1, wherein the microfiber and graphene reinforced polymer matrix composite comprises from about 5 wt. % to about 55 wt. % by total composite weight of the microfibers.

12. (canceled)

13. The method of claim 1, wherein the microfiber and graphene reinforced polymer matrix composite comprises from about 20 wt. % to about 60 wt. % of total composite weight of graphene nanoparticles, graphite microparticles, and microfibers.

14. The method of claim 1, wherein the microfibers are selected from the group consisting of single-walled carbon nanotubes, multi-walled carbon nanotubes, carbon nanofibers, micron-sized carbon fibers, chopped carbon fibers, and a combination thereof.

15. The method of claim 14, wherein the microfibers have a length ranging from about 3 mm to about 50 mm.

16. (canceled)

17. The method of claim 1, wherein the first thermoplastic polymer and the second thermoplastic polymer are independently selected from the group consisting of polyethylene terephthalate (PET), polyaryletherketones (PAEK), polyphenylene sulfides (PPS), polyethylene sulfide (PES), polyetherimides (PEI), polyvinylidene fluoride (PVDF), polysulfones (PSU), polycarbonates (PC), polyphenylene ethers, thermoplastic polyimides, liquid crystal polymers, thermoplastic elastomers, polyethylene (PE), polypropylene (PP), polystyrene (PS), acrylics, such as polymethylmethacrylate (PMMA), polyacrylonitrile (PAN), acrylonitrile butadiene styrene (ABS), polytetrafluoroethylene (PTFE/Teflon®), polyamides (PA) such as nylons, polyphenylene oxide (PPO), polyoxymethylene plastic (POM/Acetal), polyvinylchloride (PVC), and mixtures thereof.

18. A microfiber and graphene reinforced polymer matrix composite prepared according to the method of claim 1, comprising microfibers distributed into a molten polymer phase comprising exfoliated graphene, wherein said polymers are cross-linked by direct covalent bonds to the exfoliated graphene therein.

19. The microfiber and graphene reinforced polymer matrix composite of claim 18, wherein the molten polymer is selected from the group consisting of polyamide 6, polyethylene terephthalate, polypropylene, polyetheretherketone, and a combination thereof.

20-27. (canceled)

28. A polymer composition comprising a host thermoplastic polymer and the microfiber and graphene reinforced polymer matrix composite of claim 18 dispersed therein.

29. An automotive, aircraft, or aerospace part formed from the polymer composition of claim 28.

30. The part of claim 29, wherein the part is an engine part.

31. A method for forming a high-strength microfiber and graphene reinforced polymer matrix composite comprising:
forming the microfiber and graphene reinforced polymer matrix composite of claim 18; and
distributing said polymer matrix composite into a non-cross-linked molten host thermoplastic polymer phase.

32. The method of claim 31, wherein the host thermoplastic polymer is selected from the group consisting of polyethylene terephthalate (PET), polyaryletherketones (PAEK), polyphenylene sulfides (PPS), polyethylene sulfide (PES), polyetherimides (PEI), polyvinylidene fluoride (PVDF), polysulfones (PSU), polycarbonates (PC), polyphenylene ethers, thermoplastic polyimides, liquid crystal polymers, thermoplastic elastomers, polyethylene (PE), polypropylene (PP), polystyrene (PS), acrylics, such as polymethylmethacrylate (PMMA), polyacrylonitrile (PAN), acrylonitrile butadiene styrene (ABS), polytetrafluoroethylene (PTFE/Teflon®), polyamides (PA) such as nylons, polyphenylene oxide (PPO), polyoxymethylene plastic (POM/Acetal), polyvinylchloride (PVC), and mixtures thereof.
